(19) United States
(12) Patent Application Publication
(10) Pub. No.: US 2011/0159892 A1
(43) Pub. Date: Jun. 30, 2011

(54) APPARATUS AND METHOD FOR PROVIDING STATION INFORMATION OF TRANSPORTATION IN MOBILE COMMUNICATION SYSTEM

(75) Inventors: Hak-Soo KIM, Suwon-si (KR); Jong-Keun Cho, Ansan-si (KR); Chul-Sang Chang, Seoul (KR); Jeong-Eun Lee, Seongnam-si (KR)

(73) Assignee: Samsung Electronics Co., Ltd., Suwon-si (KR)

(21) Appl. No.: 12/977,567

(22) Filed: Dec. 23, 2010

(30) Foreign Application Priority Data
Dec. 24, 2009 (KR) 10-2009-0131170

(51) Int. Cl. H04W 64/00

(52) U.S. Cl. 455/456.3

(57) ABSTRACT

An apparatus and method for identifying if station information of a public transportation is information corresponding to a destination by generating and broadcasting guide information including station information to a plurality of portable terminals in a mobile communication system are provided. The apparatus includes a position information system for generating and broadcasting information on the next station, and a portable terminal for receiving the broadcasted guide information and determining if the next station is a station corresponding to a destination.

### PRIORITY

This application claims priority under 35 U.S.C. §119(a) to an application filed in the Korean Intellectual Property Office on Dec. 24, 2009 and assigned Serial No. 10-2009-0131170, the contents of which is incorporated herein by reference.

### BACKGROUND OF THE INVENTION

1. Field of the Invention

The present invention relates generally to a mobile communication system for providing information on a next station when riding public transportation. More particularly, the present invention relates to an apparatus and method for identifying if broadcasted station information of a public transportation is information corresponding to a destination, by generating guide information including station information and broadcasting the generated guide information to a plurality of portable terminals in the mobile communication system.

2. Description of the Related Art

Portable terminals are evolving into multimedia equipment for a use as a phone book, to play a game, to provide Short Message Service (SMS), to send electronic mail (e-mail) messages, to perform a morning wakeup call function, a MPEG-1 Audio Layer 3 (MP3) function, a schedule management function, a digital camera function, and to provide wireless Internet services and other services.

In recent years, as portable terminals functioning to reproduce moving pictures, MP3 and similar services have reached the market, making it possible for a user of a portable terminal to enjoy multimedia functions such as music listening, satellite broadcasting viewing, etc. when traveling on public transportation such as a bus, a subway, etc. while carrying the portable terminal without having to carry a separate multimedia reproducing equipment. Listening to music or viewing a satellite broadcast while in the bus or subway frequently will result in a user of the portable terminal failing to recognize and passing a planned debarkation station due to excess concentration on the visual sense or the hearing sense provided via the portable terminal. The phenomenon of failing to recognize a station where the user planned to get off is more noticeable in a subway, where it is more difficult for a passenger to identify his/her own position from the passing surroundings.

Generally, there are two methods to identify information on the next station.

In the first method, position information is directly acquired using a Global Positioning System (GPS), allowing a user of a portable terminal to independently determine arrival at a destination station.

The second method allows a user of a portable terminal to access a specific server in person and receive information on the next station from the specific server. The specific server is a kind of information booth from which a person obtains the necessary information.

However, once traveling on a bus or subway a problem arises in that exact positioning can often not be determined because it is difficult to receive a GPS signal. The second method for accessing the specific server has a shortcoming of a user must continuously figure out a position of a portable terminal while in motion and station arrival information from the specific server must be forwarded to the portable terminal.

### SUMMARY OF THE INVENTION

The present invention is designed to substantially solve at least the above-described problems and/or disadvantages and to provide at least the advantages described below. Accordingly, an aspect of the present invention is to provide an apparatus and method for providing station information of a public transportation in a mobile communication system.

Another aspect of the present invention is to provide an apparatus and method for generating guide information including station information in a mobile communication system.

A further aspect of the present invention is to provide an apparatus and method for acquiring station information included in guide information in a portable terminal.

The above aspects are achieved by providing an apparatus and method for providing station information of a public transportation in a mobile communication system.

In accordance with an aspect of the present invention, an apparatus for providing station information is provided that includes a receiving unit, an input unit, a memory unit, a display unit, an information analyzer, and a controller. The receiving unit searches a position information system providing station information, and receives station guide information from the position information system. The input unit inputs specific position information system information providing destination information, and the destination information. The memory unit stores a station guide information provision program, the specific position information system information, the destination information, and the station guide information. The display unit for outputting the station guide information. The information analyzer compares the received station guide information with the destination information. The controller controls to output the destination information to the display unit according to the comparison result of the information analyzer. The display unit includes a module for outputting guide information by a character, a module for outputting by an audio, and a module for outputting a control signal. The receiving unit is a local area communication device using at least any one of Wireless Fidelity (Wi-Fi), Bluetooth, and Infrared Data Association (IrDA). The specific position information system information providing the destination information inputted through the input unit is received from the position information system. The information analyzer and the controller are realized as one system.

In accordance with another aspect of the present invention, a method for providing station information is provided that includes searching a position information system providing station information, inputting specific position information system information providing destination information, and the destination information, receiving station guide information from the position information system, storing the specific position information system information, the destination information, and the station guide information, comparing the received station guide information with the destination information, and outputting the destination information according to the comparison result. The guide information is outputted using at least any one of a character, an audio, and a control signal. The guide information is received using at least any one local area communication scheme of Wi-Fi, Bluetooth, and IrDA. The specific position information system information is received from the position information system.

In accordance with another aspect of the present invention, a position information system providing station information is provided that includes a position identifying unit, a communication unit, a guide information generator, and a controller. The position identifying unit receives a satellite signal and identifies current position information. The communication unit broadcasts station guide information, which includes information on a station which the position information system is to stop at and information capable of differentiating the position information system. The guide information generator generates the station guide information. The controller controls to figure out a station which the position information system is to stop at, and generate and broadcast station guide information, which includes the station information and information capable of differentiating the position information system.

### BRIEF DESCRIPTION OF THE DRAWINGS

The above and other aspects, features and advantages of certain embodiments the present invention will become more apparent from the following detailed description when taken in conjunction with the accompanying drawings in which:

FIG. 1 is a block diagram illustrating a construction of a mobile communication system for providing guide information according to the present invention;

FIG. 2 is a flow chart illustrating a process of providing guide information in a position information system according to the present invention;

FIG. 3 is a flow chart illustrating a process of receiving guide information in a portable terminal according to the present invention;

FIG. 4 illustrates guide information used in a position information system according to an embodiment of the present invention;

FIG. 5 illustrates a process of providing guide information of a public transit in a mobile communication system according to an embodiment of the present invention; and

FIG. 6 illustrates a process of providing guide information of a public transit in a mobile communication system according to another embodiment of the present invention.

### DETAILED DESCRIPTION OF EMBODIMENTS OF THE INVENTION

The following description with reference to the accompanying drawings is provided to assist in a comprehensive understanding of certain embodiments of the present invention as defined by the claims and their equivalents. It includes various specific details to assist in that understanding although these are to be regarded as merely exemplary. Accordingly, a person having ordinary skill in the art will recognize that various changes and modifications of the embodiments described herein can be made without departing from the scope and spirit of the present invention. Also, descriptions of well-known functions and constructions are omitted for clarity and conciseness.

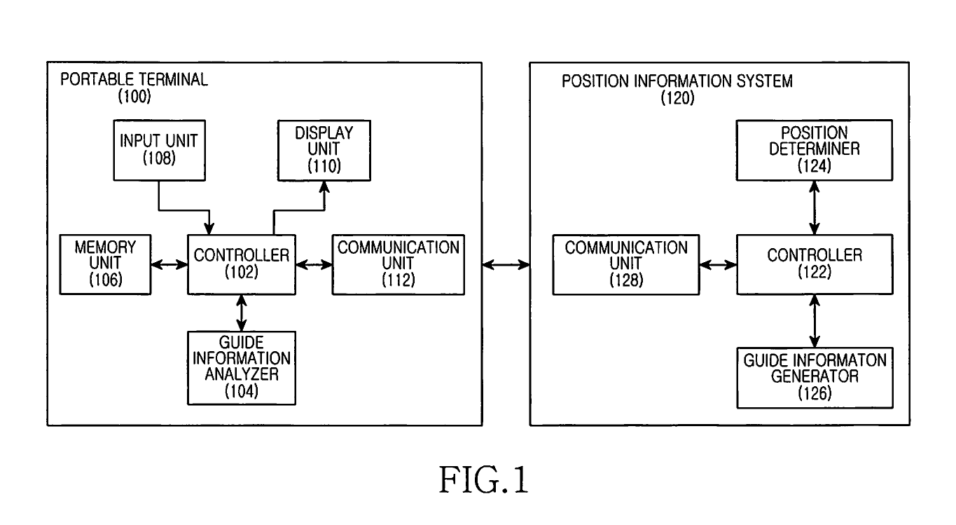

FIG. 1 is a block diagram illustrating a construction of a mobile communication system for providing guide information according to the present invention.

Referring to FIG. 1, the mobile communication system includes a portable terminal 100 for receiving guide information broadcasted from a position information system 120, and the position information system 120 for broadcasting guide information such as station information to the portable terminal 100.

The portable terminal 100 includes a controller 102, a guide information analyzer 104, a memory unit 106, an input unit 108, a display unit 110, and a communication unit 112. The position information system 120 can include a system controller 122, a position determiner 124, a guide information generator 126, and a communication unit 128. The portable terminal may include additional units, and functionality of two or more of the above units may be integrated into a single component.

The controller 102 of the portable terminal 100 controls a general operation of the portable terminal 100. According to the present invention, the controller 102 receives guide information broadcasted from the position information system 120, and informs a user of arrival at a destination using the received guide information.

In order to inform the user of the arrival at the destination, the controller 102 determines if the received guide information is its own necessary guide information, and receives only its own necessary guide information through filtering. Here, its own necessary guide information refers to guide information broadcasted from the position information system 120, which is installed in a public transportation upon which a user of the portable terminal 100 travels on with the portable terminal 100.

The guide information analyzer 104 analyzes guide information broadcasted from the position information system 120, determines if the guide information is guide information desired by the portable terminal 100, and determines the next station using station information included in the guide information.

The memory unit 106 includes a Read Only Memory (ROM), a Random Access Memory (RAM), a flash ROM, or the like to store a microcode of a program for processing and controlling the controller 102 and the guide information analyzer 104 and a variety of reference data.

The RAM, a working memory of the controller 102, stores temporary data generated during execution of a variety of kinds of programs. The flash ROM stores a diversity of updateable depository data such as a phone book, an outgoing message, and an incoming message.

The input unit 108 includes numeral key buttons ‘0’ to ‘9’, a menu button, a cancel button, an OK button, a talk button, an end button, an Internet button, navigation key (or direction key) buttons, and a plurality of function keys such as a character input key. The input unit 108 provides the controller 102 with key input data corresponding to a key pressed by a user.

The display unit 110 displays state information generated during operation of the portable terminal 100, characters, a large amount of moving pictures and still pictures, and the like. The display unit 110 can be a color Liquid Crystal Display (LCD), an Active Mode Organic Light Emitting Diode (AMOLED). When the display unit 110 includes a touch input device and is applied to a portable terminal operation using a touch input scheme, the display unit 110 can be used as an input device of the portable terminal.

The communication unit 112 transmits/receives and processes a radio signal of data inputted/outputted through an antenna (not illustrated). For example, in a transmission mode, the communication unit 112 processing original data through channel coding and spreading, converts the original data into a Radio Frequency (RF) signal, and transmits the RF signal. In a reception mode, the communication unit 112 converts a received RF signal into a baseband signal, processes the baseband signal through de-spreading and channel decoding, and restores the signal to original data. According to the present invention, the communication unit 112 can be operated as a receiver receiving guide information in at least one of Wireless Fidelity (Wi-Fi), Bluetooth, and Infrared Data Association (IrDA) communication schemes.

A role of the guide information analyzer 104 can be implemented by the controller 102 of the portable terminal 100. However, these are separately constructed and shown in the present invention as an exemplary construction for description convenience, without limiting the scope of the present invention. For example, construction can also be such that all of them are processed in the controller 102.

According to the present invention, the system controller 122 of the position information system 120 determines position information, determines a current position of a public transportation vehicle equipped with the position information system 120, and searches a station which the public transportation vehicle (i.e., the position information system 120) will arrive.

After that, the system controller 122 generates and broadcasts guide information, which includes information on the searched station and information capable of differentiating the position information system 120. The differentiating the position information system 120 means identifying each specific information system.

The position determiner 124 includes a satellite signal receiving module for receiving a satellite signal and determining current position information.

The guide information generator 126 generates guide information about a station to be broadcasted to the portable terminal 100. In detail, under the control of the system controller 122, the guide information generator 126 generates guide information, which includes information on a station which the position information system 120 is to stop at and information to differentiate the position information system 120.

The communication unit 128 broadcasts guide information generated by the guide information generator 126. The communication unit 128 can include a Bluetooth module, a wireless Local Area Network (LAN) module, or an IrDA module.

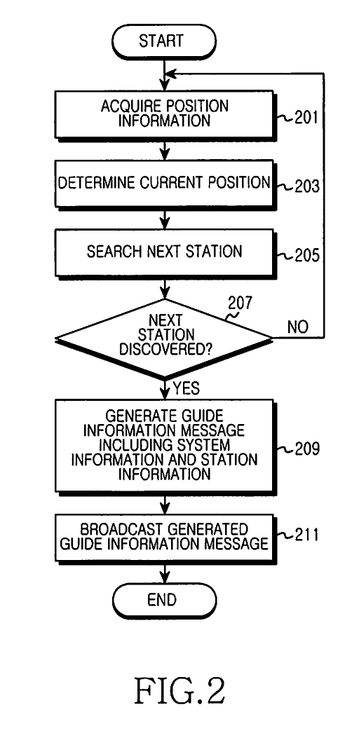

FIG. 2 is a flow diagram illustrating a process of providing guide information in a position information system according to the present invention.

In step 201 of FIG. 2, the position information system acquires position information of the position information system. After that, the position information system in step 203 determines a current position of the position information system using the acquired position information.

The position information system proceeds to step 205 and searches for the next station. That is, the position information system determines the station at which the position information system is to arrive from among stations included in a route which the position information system follows based, on the current position determined in step 203.

Next, the position information system proceeds to step 207 and determines whether the next station is discovered. That is, step 207 determines if the next station searched in step 205 exists near the position information system.

If the next station is not discovered in step 207, the position information system returns to step 201 and repeats the above described a procedure of discovering the next station at which the position information system will arrive.

On the other hand, the next station is discovered in step 207. In other words, if it is determined that the searched next station of step 205 exists near the position information system, the position information system proceeds to step 209 and generates guide information, which includes system information capable of differentiating the position information system from a different position information system and information on a station at which the position information system will arrive.

Here, the position information system can generate guide information including information on a plurality of arrival stations, and guide information including the estimated time of arrival at the arrival station. That is, the position information system transmits information on one station at which the position information system will next arrive and two stations at which the position information system will then arrive based on the station at which the position information system will presently arrive (i.e., information on a total of three stations) to a portable terminal, and transmits the estimated time of arrival at each station or the guided last station to the portable terminal, allowing the portable terminal to estimate a time of arrival at a destination.

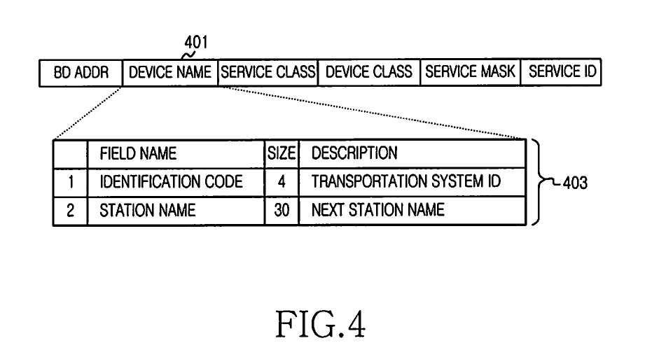

Also, the position information system can include the guide information in information broadcasted to recognize a peripheral portable terminal, as described in detail in regard to FIG. 4 below.

For example, the position information system can include the guide information in a Device Discovery Response Record broadcasted to recognize a peripheral Bluetooth device via Bluetooth communication. Accordingly, portable terminals supporting the Bluetooth communication receive the information broadcasted to recognize the Bluetooth device, thereby receiving the guide information even when no connection with the position information system is available.

The position information system then proceeds to step 211 and broadcasts the guide information generated in step 209 and then terminates the process.

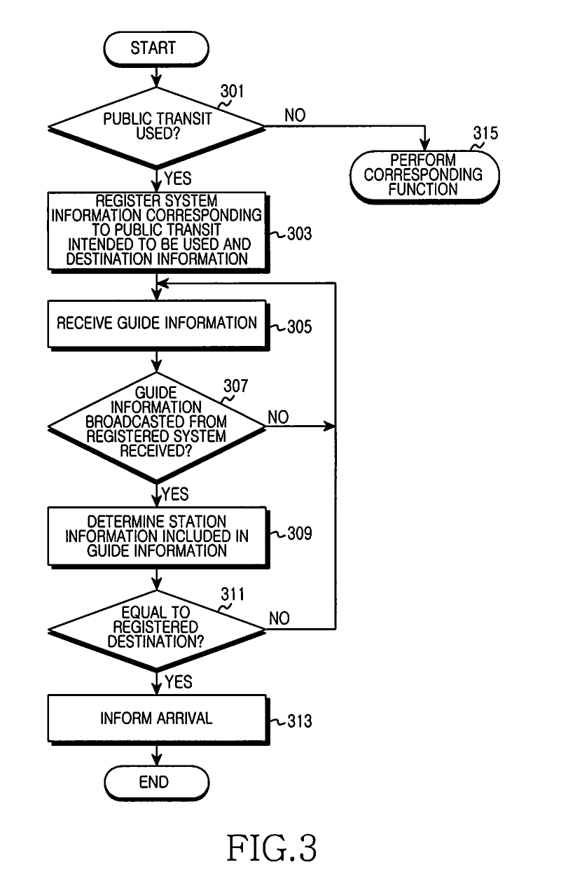

FIG. 3 is a flow diagram illustrating a process of receiving guide information in a portable terminal according to the present invention.

Referring to FIG. 3, regarding which it is assumed that the portable terminal is operating a local area communication module, in step 301, the portable terminal enabling local area communication determines whether public transit. That is, the portable terminal determines if a user of the portable terminal is to use public transit equipped with a position information system.

If determined that public transit will not be used in step 301, the portable terminal proceeds to step 315 and performs a corresponding function, such as returning to an idle mode.

On the other hand, if determined that public transit will be used in step 301, the portable terminal proceeds to step 303 and registers both information on a system corresponding to the public transit intended to be used and destination information. Here, the user of the portable terminal can register both system information of the position information system installed in the public transit and information on a station to which the user is to travel, to the portable terminal at the time of using the public transit.

The portable terminal then proceeds to step 305 and receives guide information broadcasted from the position information system. After that, the portable terminal proceeds to step 307 and determines whether the guide information has been received from the system registered in step 305.

The portable terminal receives the broadcasted guide information and also guide information broadcasted from another peripheral position information system. The another peripheral position information system is an information system installed, for example, in another public bus in opposite bus line.

As the above conditions cannot provide accurate guide information to the portable terminal, the portable terminal determines whether received guide information corresponds to a previously registered position information system.

In step 307, after the position information system acquires information capable of differentiating a position information system from the received guide information, the position information system determines whether the acquired information is equal to the information registered in step 303.

If in step 307 it is determined that guide information from a previously registered system is not received, for example, if receiving guide information from a position information system installed in a peripheral different public transit, the portable terminal returns to step 305 and receives guide information broadcasted from its own registered location information system.

On the other hand, if in step 307 it is determined that the guide information from the previously registered system is received, the portable terminal proceeds to step 309 and determines station information included in the received guide information

Next, the portable terminal proceeds to step 311 and determines if the station information included in the received guide information is equal to its own registered destination information. That is, the portable terminal determines whether a station at which a public transit equipped with the position information system is to stop at is consistent with its own destination.

If the station information included in the received guide information is determined not to be equal to its own registered destination information in step 311, the portable terminal returns to step 305 until receiving guide information including station information equal to its own destination information.

On the other hand, if it is determined in step 311 that the station information included in the received guide information is equal to the its own registered destination information, the portable terminal proceeds to step 313 and informs a user of arrival at a destination through beep sound, vibration, etc. and then, terminates the process.

In addition, in case that the portable terminal receives guide information including both three pieces of station information and the estimated time of arrival from the position information system, the portable terminal can provide the estimated time of arrival to the user beforehand.

FIG. 4 is a diagram illustrating guide information used in a position information system according to an embodiment of the present invention

Referring to FIG. 4, the guide information can be included in information used to recognize a peripheral terminal so that the guide information can be transmitted to a plurality of terminals without connecting with a specific terminal as described above.

For example, the guide information can be included in a Device Discovery Response Record broadcasted to recognize a peripheral Bluetooth device via Bluetooth communication. Accordingly, portable terminals supporting the Bluetooth communication receive the information broadcasted to recognize the Bluetooth device, thereby receiving the guide information even when no connection with the position information system is available.

Here, the position information system can include both information on the position information system and information on a station at which it is expected to arrive (403), in a Device Name field (401) corresponding to a device name of the Device Discovery Response Record.

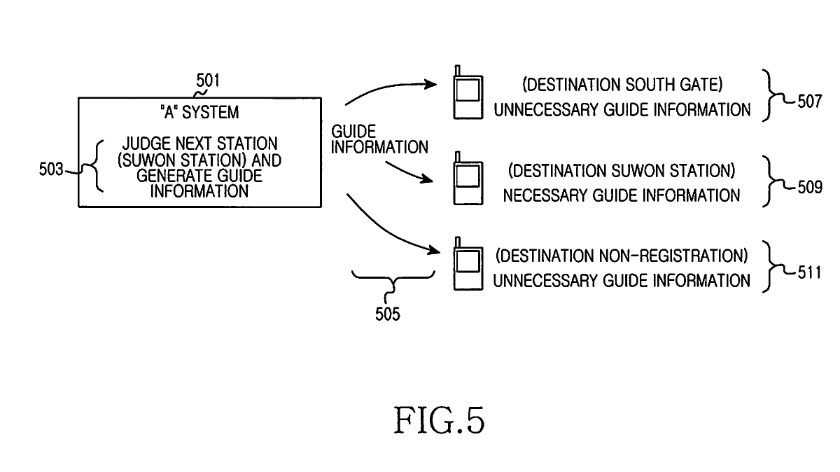

FIG. 5 is a diagram illustrating a process of providing guide information of a public transit in a mobile communication system according to an embodiment of the present invention.

Referring to FIG. 5, the mobile communication system includes a position information system for determining and broadcasting position information and the next station, and a portable terminal for receiving guide information broadcasted by the position information system and providing the received guide information to a user.

The position information system is installed in a public transportation, and collects position information and provides information on the next station to a user. Here, the position information system includes a local area communication module, and generates and broadcasts guide information, which includes information on the next station and information capable of differentiating the position information system. At this time, when broadcasting the guide information through Bluetooth communication, the position information system can broadcast the guide information by including the guide information in the Device Discovery Response Record broadcasted to recognize a peripheral Bluetooth device.

For example, when an ‘A’ position information system 501 determines that the next station is the Suwon Station, the ‘A’ system 501 generates (503) and broadcasts (505) guide information, which includes information about the ‘A’ system and information about the Suwon Station.

Accordingly, portable terminals using a public transit equipped with the ‘A’ position information system will receive the guide information.

As the portable terminals register system information of the position information system and a destination while boarding on the public transit, the portable terminals can determine if the received guide information is its own necessary information.

In detail, a portable terminal 507 registering a destination as the South Gate and a portable terminal 511 that does not register a destination will determine that the received guide information is unnecessary information. A portable terminal 509 registering a destination as the Suwon Station determines that the received guide information is information corresponding to the portable terminal 509 itself and informs a user of arrival at the destination.

To solve a problem of power consumption caused by an operation of a communication module for guide information reception, the portable terminal can change a period of guide information reception. For example, when a user can estimate a required time of arrival at a destination, the user will set the estimated time of arrival and, when getting closer to the estimated time of arrival, makes a period of guide information reception shorter, thus reducing battery consumption.

In addition, when the portable terminal 507 registering the destination as the South Gate receives guide information including information informing of arrival at the South Gate after three stations and the estimated time of arrival at the South Gate after the three stations, the portable terminal 507 can notify the user of the estimated time of arrival at the South Gate that is the destination.

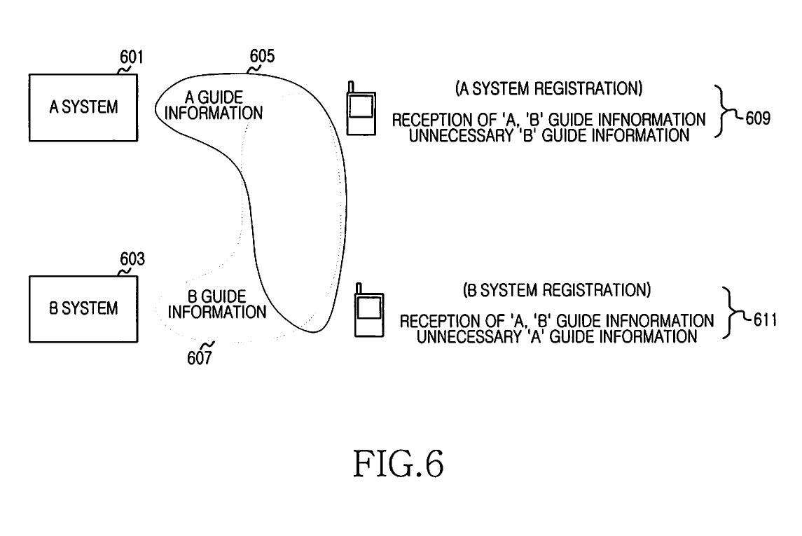

FIG. 6 is a diagram illustrating a process of providing guide information of a public traffic in a mobile communication system according to an embodiment of the present invention.

Referring to FIG. 6, the mobile communication system can include two or more position information systems, and portable terminals for receiving guide information broadcasted by the position information systems and providing the received guide information to a user. Here, the two or more position information systems represent that a plurality of position information systems that exist in adjacent areas.

For example, assuming that an ‘A’ position information system 601 and a ‘B’ position information system 603 exist in adjacent areas as shown, the position information systems generate and broadcast guide information (605) and (607), respectively.

Peripheral portable terminals will receive the guide information (605) and (607) broadcasted by the two or more position information systems.

The portable terminal receiving the two pieces of guide information as above actually requires only one piece of guide information. That is, the portable terminal shall receive unnecessary guide information among the two pieces of guide information.

If receiving each guide information from the ‘A’ position information system and the ‘B’ position information system, the portable terminal can receive only guide information broadcasted by its own registered position information system by filtering the unnecessary guide information.

That is, of ‘A’ guide information and ‘B’ guide information received from the ‘A’ position information system and the ‘B’ position information system, a portable terminal 309 registered to the ‘A’ position information system receives only the ‘A’ guide information by filtering the ‘B’ guide information.

On the contrary, of the ‘A’ guide information and the ‘B’ guide information received from the ‘A’ position information system and the ‘B’ position information system, a portable terminal 611 registered to the ‘B’ position information system receives only the ‘B’ guide information by filtering the ‘A’ guide information.

As described above, the present invention, which relates to an apparatus and method for generating guide information including station information and providing station information of a public transportation to a plurality of portable terminals in a mobile communication system, generates and broadcasts information on the next station, thereby being capable of determining whether the next station is a station corresponding to a destination in a peripheral portable terminal.

While the invention has been shown and described with reference to certain embodiments thereof, it will be understood by those skilled in the art that various changes in form and details may be made therein without departing from the spirit and scope of the invention as defined by the appended claims.

What is claimed is:

1. An apparatus for providing station guide information, the apparatus comprising:
a receiving unit for receiving station guide information from the position information system;
an input unit for inputting information of the position information system providing the station guide information and a destination information;
a memory unit for storing a provision program for operating to provide the station guide information, information of the position information system, the destination information, and the station guide information;
a output unit for outputting the station guide information;
an information analyzer for comparing the received station guide information with the destination information; and
a controller for controlling to notify the comparison result of the information analyzer to the user through the output unit.

2. The apparatus of claim 1, wherein the receiving unit searches the position information system providing station guide information.

3. The apparatus of claim 1, wherein the output unit comprises a module for outputting guide information by a character, a module for outputting by an audio, and a module for outputting a control signal.

4. The apparatus of claim 1, wherein the receiving unit is a local area communication device using one of Wireless Fidelity (Wi-Fi), Bluetooth, and Infrared Data Association (IrDA).

5. The apparatus of claim 1, wherein the specific position information system information providing the destination information inputted through the input unit is received from the position information system.

6. The apparatus of claim 1, wherein the station guide information includes an estimated time of arrival at a user input destination.

7. The apparatus of claim 1, wherein the position information system is installed in a mobile vehicle.

8. The apparatus of claim 7, wherein the mobile vehicle is one of a car, a bus, a train, and a taxi.

9. The apparatus of claim 1, wherein the controller determines if the received station guide information is equal to previously registered destination information according to the comparison result of the information analyzer.

10. The apparatus of claim 1, wherein, when the received station guide information is equal to the previously registered destination information, the controller provides destination notification to a user through the display unit.

11. The apparatus of claim 1, wherein the information analyzer judges if the received station guide information is information provided by the previously registered position information system.

12. The apparatus of claim 1, wherein the guide information analyzer operates according to a user input period.

13. The apparatus of claim 1, wherein the output unit is at least one of a display, an audio and a beep.

14. A method for providing station guide information, the method comprising:
inputting information of the position information system providing the station guide information and inputting the destination information from an user;
receiving station guide information from the position information system;
storing information of the position information system providing station guide information, the destination information, and the station guide information;
comparing the received station guide information with the destination information; and
outputting the comparison result through a output unit.

15. The method of claim 14, further comprising:
searching a position information system providing station guide information before the step of receiving station guide information from the position information system.

16. The method of claim 14, wherein the guide information is outputted using one of a character, an audio, and a control signal.

17. The method of claim 14, wherein the guide information is received using at least any one local area communication scheme of Wireless Fidelity (Wi-Fi), Bluetooth, and Infrared Data Association (IrDA).

18. The method of claim 14, wherein the specific position information system information is received from the position information system.

19. The method of claim 14, wherein the station guide information includes an estimated time of arrival at a user input destination.

20. The method of claim 14 wherein the position information system is installed in a mobile vehicle.

21. The method of claim 14, wherein the mobile vehicle is one of a car, a bus, a train, and a taxi.

22. The method of claim 21, wherein comparing the received station guide information with the destination information determines if the received station guide information is equal to previously registered destination information according to the comparison result.

23. The method of claim 14, wherein outputting the destination information according to the comparison result provides destination notification to a user in case that the received station guide information is equal to the previously registered destination information.

24. The method of claim 14, wherein comparing the received station guide information with the destination information determines if the received station guide information is information provided by the previously registered position information system.

25. The method of claim 14, wherein comparing the received station guide information with the destination information is performed according to a user input period.

26. The method of claim 14, wherein the guide information is outputted using at least one of displayed characters, audio signals, and beep signals.

27. A position information system providing station guide information, the system comprising:
a position determiner for receiving a satellite signal and determining current position information;
a communication unit for broadcasting station guide information, which includes information on a station where the position information system will stop and information for differentiating between differing the position information systems;
a guide information generator for generating the station guide information; and
a controller for determining which station the position information system will stop at, and for generating and broadcasting station guide information, which includes the station guide information and information capable of differentiating the position information system.

28. The system of claim 27, wherein the guide information generator generates station guide information including information on the estimated time of arrival at a user input destination.

29. The system of claim 27, wherein the controller includes the station guide information in information broadcasted to recognize a peripheral portable terminal.

30. The system of claim 27, wherein the controller determines a station which the position information system is to arrive at, using a current position of a public transit determined by the position determiner.
